(19) United States
(12) Patent Application Publication
(10) Pub. No.: US 2010/0288750 A1
(43) Pub. Date: Nov. 18, 2010

(54) Heating pad assembly with less magnetic waves field of the invention

(76) Inventor: Shu -Lien Chen, Taichung (TW)

Correspondence Address: SHE-LIEN CHENB, P. O. BOX 55-124, TAICHUNG, TW

(21) Appl. No.: 12/453,638

(22) Filed: May 18, 2009

(51) Int. Cl. H05B 3/34

(52) U.S. Cl. 219/528

(57) ABSTRACT

A heating pad assembly includes a base made of non-conductive material and a heating circuit made of metallic material with resistance and being a continuous elongate band. Two terminals are connected to the two respective ends of the heating circuit so as to introduce current to the heating circuit. The heating circuit is composed of two heating bands and a connection band. The two heating bands are located in pair and symmetrically. Two first ends of the two heating bands are connected to the two terminals and two second ends of the two heating bands are connected to the connection band. The magnetic waves generated from the two heating bands are in opposite directions and neutralized mutually.

### FIELD OF THE INVENTION

The present invention relates to a heating pad assembly and more particularly, to a resistance-type heating pad assembly which generates less magnetic waves.

### BACKGROUND OF THE INVENTION

A conventional heating pad with less magnetic waves is shown in FIG. 1, and generally includes a hose 1 and a base 2, the hose 1 is connected to a cable 3 through the electric power is transferred. The hose 1 involves resistance which generates heat when current passes therethrough. As shown in FIG. 2, the hose 1 includes a heating wire 102 and a circuit wire 104 which is parallel to the heating wire 102. The two respective first ends of the heating wire 102 and the circuit wire 104 are connected to each other, and the two respective second ends of the heating wire 102 and the circuit wire 104 are connected to the cable 3. When current passes through the heating wire 102 and the circuit wire 104, the current moves in two opposite directions in the heating wire 102 and the circuit wire 104, so that most of the magnetic waves can be reduced because of their directions.

Although the heating pad generates certain temperature to warm the users and the magnetic waves are reduced, the circuit wire 104 actually does not generate heat. In other words, only the heating wire 102 generates heat which is not sufficient. Besides, the circuit wire 104 includes low resistance which can generates less magnetic waves when compared with the magnetic waves generated from the heating wire 102 which has higher resistance. The conventional heating pad still generates significant magnetic waves.

The present invention intends to provide a heating pad assembly which includes two heating bands arranged in pair and symmetrically so as to efficiently reduce the magnetic waves while providing sufficient temperature.

### SUMMARY OF THE INVENTION

The present invention relates to a heating pad assembly which comprises a base made of non-conductive material and a heating circuit made of metallic material with resistance. The heating circuit is a continuous elongate band. Two respective ends of the heating circuit have two terminals via which current passes. The heating circuit is composed of two heating bands and a connection band. The two heating bands are located in pair. Two first ends of the two heating bands are connected to the two terminals and two second ends of the two heating bands are connected to the connection band.

The primary object of the present invention is to provide a heating pad assembly which includes two heating bands located in parallel to each other, the current goes through the two heating bands in opposite directions such that the magnetic waves generated from the two heating bands are neutralized mutually.

Another object of the present invention is to provide a heating pad assembly which is slim and includes less magnetic waves.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional heating pad;

FIG. 2 is a cross sectional view to show the hose in the conventional heating pad;

FIG. 3 shows a first embodiment of the heating pad assembly of the present invention;

FIG. 4 shows two conductive wires are connected to the terminals of the first embodiment of the heating pad assembly of the present invention;

FIG. 5 shows that the current pass through the two heating bands in two opposite directions;

FIG. 6 shows a second embodiment of the heating pad assembly of the present invention;

FIG. 7 shows a third embodiment of the heating pad assembly of the present invention;

FIG. 8 shows a fourth embodiment of the heating pad assembly of the present invention;

FIG. 9 shows a fifth embodiment of the heating pad assembly of the present invention,

FIG. 10 shows a sixth embodiment of the heating pad assembly of the present invention, and

FIG. 11 shows a seventh embodiment of the heating pad assembly of the present invention.

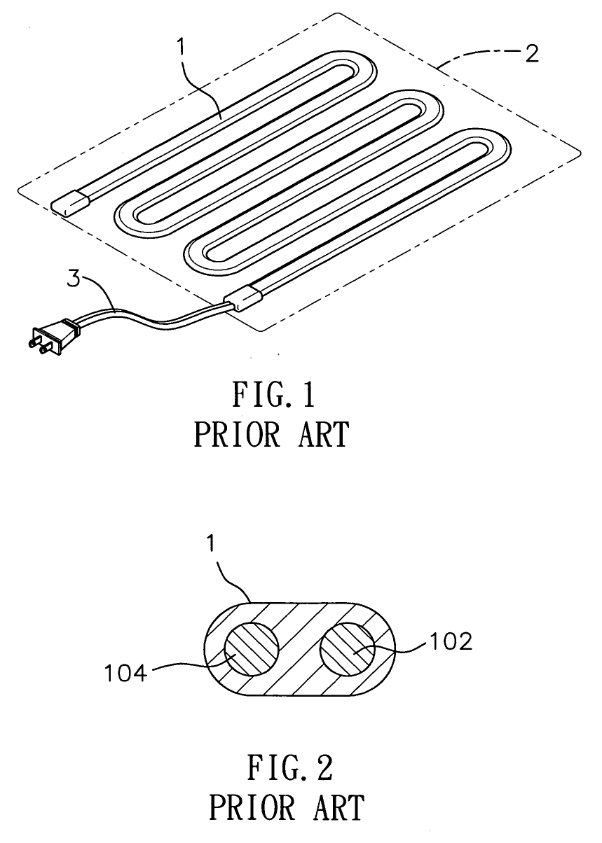

### DETAILED DESCRIPTION OF THE PREFERRED EMBODIMENT

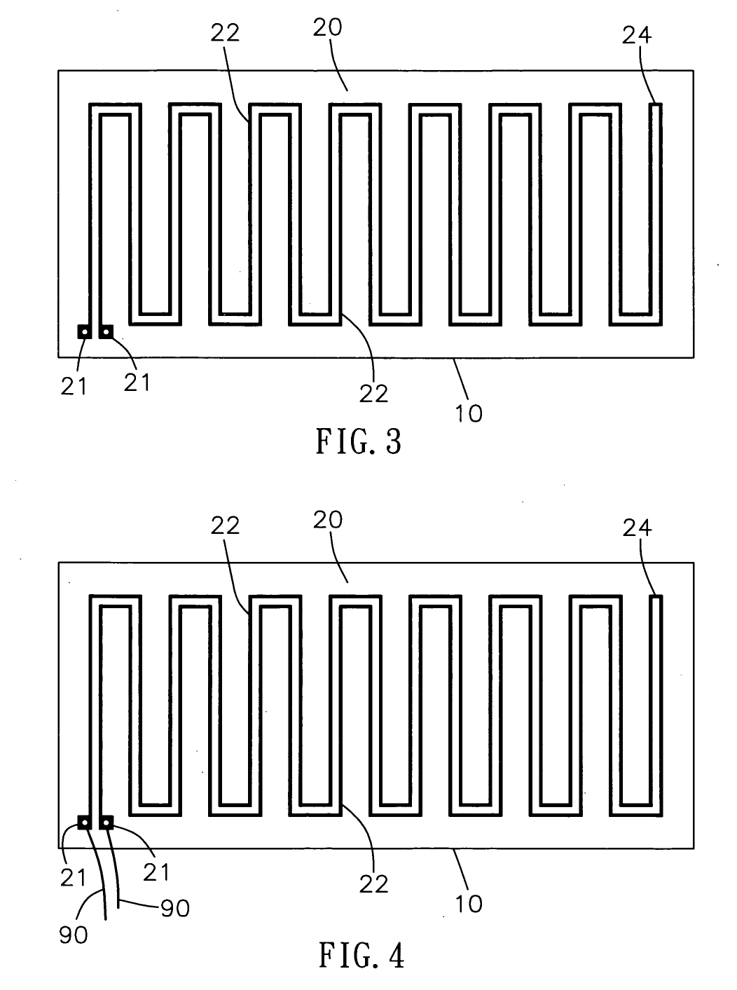

Referring to FIGS. 3 and 4, the heating pad assembly of the present invention comprises a base 10 and a heating circuit 20, wherein the base 10 is made of non-conductive material and a slim pad. The heating circuit 20 is a continuous elongate band and made of metallic material with resistance. The heating circuit 20 is connected to a surface of the base 20 in a continuous S-shaped route. Two respective ends of the heating circuit 20 has two terminals 21 and two conductive wires 90 are connected to the two terminals 21 so as to introduce current to passes through the heating circuit 20. The heating circuit 20 is composed of two heating bands 22 and a connection band 24. The two heating bands 22 are located in pair and symmetrically. Two first ends of the two heating bands 22 are connected to the two terminals 21 and two second ends of the two heating bands 22 are connected to the connection band 24.

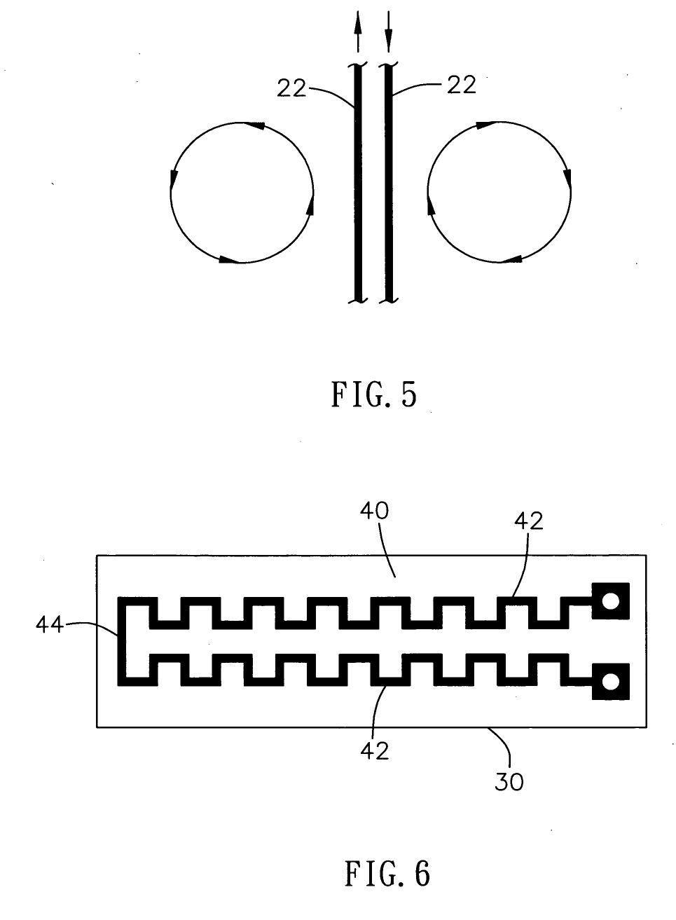

When the conductive wires 90 are connected to a power source which is not shown, the current passes the heating circuit 20 and the two heating bands 22 generate heat because of their resistance. As shown in FIG. 5, the current passes through the two heating bands 22 in two opposite directions so that the magnetic waves that are generated from the two heating bands 22 are in opposite directions and neutralized mutually. By this specific arrangement, the heating pad assembly generates less magnetic waves then the conventional heating pad.

The following chart is the result of the tests applied to the heating pad assembly of the present invention and the conventional heating pad. The magnetic waves are measured by mG and the area of the heating pad assembly of the present invention and the conventional heating pad is 80 cm×180 cm, the voltage of the current is 110 Voltage and the power is 174 Watt.

| | 0 cm | 10 cm | 20 cm |
|---|---|---|---|
| The heating pad | 6 mG | 1.7 mG | 1 mG |
| assembly of the present | | | |
| invention | | | |
| The conventional | 181.5 mG | 75 mG | 45 mG |
| heating pad | | | |

As shown in FIG. 6 which is the second embodiment of the heating pad assembly of the present invention, and includes a base 30 and a heating circuit 40, both of which are the same as the first embodiment. The base 30 is made of non-conductive material and a slim and elongate pad. The heating circuit 40 is connected to a surface of the base 30 and includes two heating bands 42 and a connection band 44. The two heating bands 42 are located substantially parallel to each other so as to eliminate the magnetic waves as described.

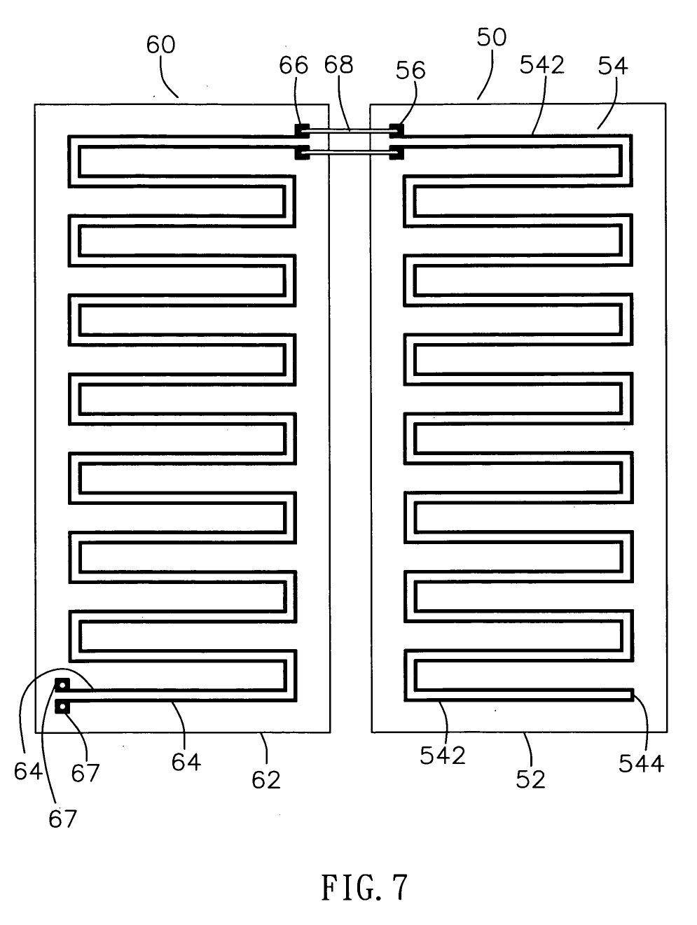

As shown in FIG. 7 which is a third embodiment of the heating pad assembly of the present invention and comprises a first heating pad 50 and a second heating pad 60, wherein the first heating pad 50 has a first base 52 and a first heating circuit 54 which is connected to a surface of the first base 52. The first heating circuit 54 is composed of two first heating bands 542 and a first connection band 544. The two first heating bands 542 are located in pair and symmetrically. Two first terminals 56 are connected to two respective first ends of the two first heating bands 542 and two ends of the first connection band 544 are connected to two respective second ends of the first heating bands 542.

The second heating pad 60 has a second base 62 and two second heating bands 64 are connected to a surface of the second base 62. The two second heating bands 64 each have a first end and a second end. The two respective first ends of the two second heating bands 64 have two second terminals 66, 66 connected thereto. The two respective second ends of the two second heating bands 64 have two third terminals 67, 67 connected thereto. Two connection wires 68 are connected between the two first terminals 56 and the two second terminals 66. The second heating bands 64 are connected to the surface of the second base 60 in a continuous S-shaped route and the connection wires 68 are located parallel to each other at a distance.

The two third terminals 67, 67 are connected to the power source (not shown) and current goes through the two second heating bands 64, the connection wires 68 and the two first heating bands 542 to form a circuit. The first and second heating bands 542, 64 generate temperature and the magnetic waves generated from the first and second heating bands 542, 64 are neutralized mutually.

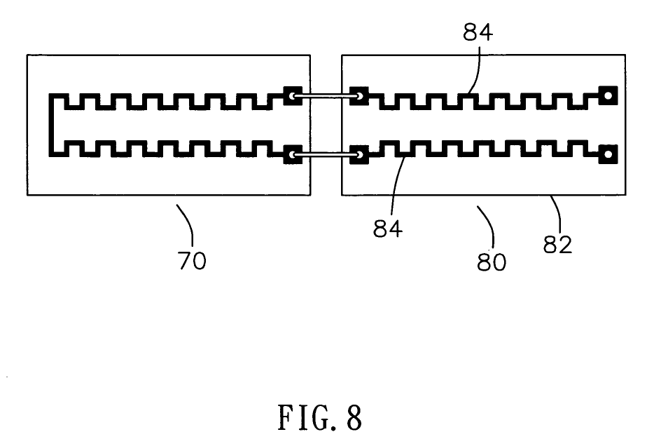

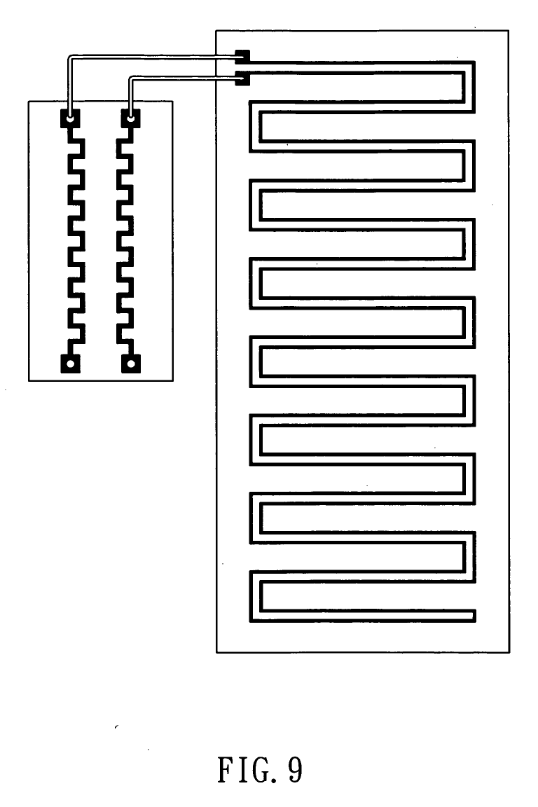

As shown in FIG. 8 which is a fourth embodiment of the heating pad assembly of the present invention and comprises two heating pads which are the first heating pad 70 and the second heating pad 80. Two connection wires 88 are connected between the first and second heating pads 70, 80. The first heating pad 70 is the same as that disclosed in FIG. 6 and the second heating pad 80 includes a base 82 and two heating bands 84 which are located in pair and symmetrically. The power source is connected to the two terminals on the heating bands 84 on the right of the drawing.

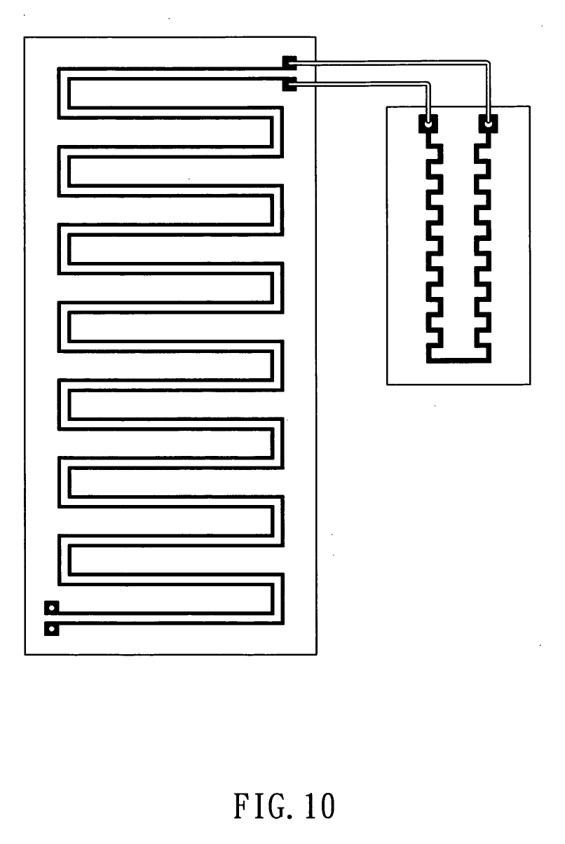

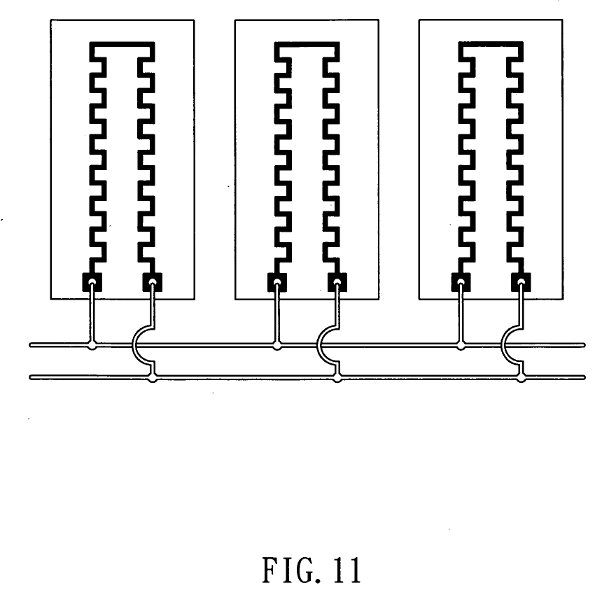

FIG. 9 shows is a fifth embodiment of the heating pad assembly of the present invention which is composed of the first embodiment (FIG. 3) and the right part of the fourth embodiment (FIG. 8). FIG. 10 shows is a sixth embodiment of the heating pad assembly of the present invention which is composed of the left part of the third embodiment (FIG. 7) and the right part of the fourth embodiment (FIG. 8). FIG. 11 shows is a seventh embodiment of the heating pad assembly of the present invention.

While we have shown and described the embodiment in accordance with the present invention, it should be clear to those skilled in the art that further embodiments may be made without departing from the scope of the present invention.

What is claimed is:

1. A heating pad assembly comprising:
a base made of non-conductive material, and
a heating circuit made of metallic material with resistance and being a continuous elongate band, two respective ends of the heating circuit having two terminals via which current passes, the heating circuit composed of two heating bands and a connection band, the two heating bands located in pair, two first ends of the two heating bands connected to the two terminals, two second ends of the two heating bands connected to the connection band.

2. The assembly as claimed in claim 1, wherein the heating circuit is connected to a surface of the base in a continuous S-shaped route.

3. The assembly as claimed in claim 1, wherein the heating bands are located symmetrically to each other.

4. A heating pad assembly comprising:
a first heating pad having a first base and a first heating circuit which is connected to a surface of the first base, the first heating circuit composed of two first heating bands and a first connection band, the two first heating bands located in pair, two first terminals connected to two respective first ends of the two first heating bands, two ends of the first connection band connected to two respective second ends of the first heating bands, and
a second heating pad having a second base and two second heating bands connected to a surface of the second base, the two second heating bands each having a first end and a second end, the two respective first ends of the two second heating bands having two second terminals connected thereto, the two respective second ends of the two second heating bands having two third terminals connected thereto, two connection wires connected between the two first terminals and the two second terminals.

5. The assembly as claimed in claim 4, wherein the second heating bands are connected to the surface of the second base in a continuous S-shaped route.

6. The assembly as claimed in claim 4, wherein the second heating bands are located symmetrically to each other.

7. The assembly as claimed in claim 4, wherein the connection wires are located parallel to each other at a distance.
